(19) United States
(12) Patent Application Publication
(10) Pub. No.: US 2021/0122556 A1
(43) Pub. Date: Apr. 29, 2021

(54) Recyclable High Barrier Packaging Films and Methods of Making Same

(71) Applicant: Wisepac USA Inc, Marlton, NJ (US)

(72) Inventor: Fei SHEN, Cherry Hill, NJ (US)

(73) Assignee: Wisepac USA Inc., Marlton, NJ (US)

(21) Appl. No.: 17/073,476

(22) Filed: Oct. 19, 2020

Related U.S. Application Data
(60) Provisional application No. 62/924,734, filed on Oct. 23, 2019.

(51) Int. Cl. B65D 81/20; B65D 81/26; B65D 65/22; B32B 27/20; B32B 27/28; B32B 15/20; B32B 37/00

(52) U.S. Cl. CPC B65D 81/2084; B65D 81/267; B65D 65/22; B32B 27/20; B32B 2439/06; B32B 15/20; B32B 37/0053; B32B 2307/75; B32B 2307/726; B32B 27/285

(57) ABSTRACT

A high barrier packaging film has an outer layer of a high molecular polymer or a spunbond nonwoven fabric comprising a high molecular polymer, a passive barrier layer of the same high molecular polymer with nanoparticles of bentonite clay dispersed therein, an active barrier layer of the same high molecular polymer with desiccant particles dispersed therein, and a lamination layer of the same high molecular polymer. The outer layer, passive barrier layer and active barrier layer are compound laminated with the lamination layer to form the high barrier packaging film. Because the layers are all formed of a same polymer, such as polyethylene, and because there are no metal components in the layers used to create the film, the high barrier packaging film is readily recyclable.

### CROSS-REFERENCE TO RELATED APPLICATION

This application claims priority under 35 USC § 119(e) to U.S. Provisional Application Ser. No. 62/924,734, entitled “Recyclable High Barrier Packaging Films and Methods of Making Same”, filed Oct. 23, 2019, the disclosure of which is incorporated by reference herein.

### FIELD OF THE INVENTION

The present invention is generally directed to high barrier packaging films that are formed of layers of a same type of high molecular polyethylene or binder so that the resulting films are more readily recyclable. The high barrier packaging films include among the provided layers thereof a passive barrier layer in combination with an active barrier layer.

### BACKGROUND OF THE INVENTION

Barrier materials are coatings or multilayer combinations of plastics designed to reduce water and gas diffusion into and/or out of a rigid or flexible package.

Controlling moisture migration is crucial to maintaining the taste, texture, and overall quality of packaged food products. High-barrier packaging helps retain rich flavors and aromas by creating a tightly sealed barrier system. The barrier film works to efficiently block oxygen transmission and water vapor from contacting sensitive foods and pharmaceuticals stored within packaging made with the barrier film. The relative humidity within the packaging optimally is maintained at a desired level. “Relative humidity” (RH %) is the ratio of the partial pressure of water vapor to the equilibrium vapor pressure of water at a given temperature.

Existing high barrier packaging materials and films generally incorporate aluminum foil to ensure high barrier functionality, and generally also have two or more types of high-molecular plastic film as main components. Alternatively, existing high barrier packaging materials use high-molecular plastics with plant fibers in combination with aluminum foil. The existing high barrier packaging materials are formed from multiple layers that are laminated together using binders. Printing is mainly performed at the surface of outer layer. The barrier functionality is achieved by incorporating aluminum foil in one or more of the layers. Because existing high barrier packaging materials/films include multiple ingredients (e.g., metal(s) together with polymer(s)), they are not readily recyclable.

As waste management continues to be a high priority for industry and consumers, materials that are more readily recycled are desired. Accordingly, improvements to high barrier packaging films continue to be sought.

### BRIEF SUMMARY OF THE INVENTION

In a first embodiment of the invention, a high barrier packaging film has an outer layer of spunbond nonwoven fabric comprising a first high molecular polymer, a passive barrier layer comprising the first high molecular polymer with nanoparticles of bentonite clay dispersed therein, an active barrier layer comprising the first high molecular polymer with desiccant particles dispersed therein, and a lamination layer comprising the first high molecular polymer. The outer layer, passive barrier layer and active barrier layer are compound laminated with the lamination layer to form the high barrier packaging film.

The first high molecular polymer can be one polymer selected from polyethylene, ethylene acrylic acid copolymer, ethylene vinyl acetate copolymer or ethylene acrylate copolymer. In a preferred embodiment, first high molecular polymer is polyethylene. Importantly, none of the outer layer, passive barrier layer, and active barrier layer comprise a metal, such as aluminum.

The desiccant particles in the active barrier layer may comprise ultra-fine molecular sieve desiccant.

In a second embodiment of the invention, a high barrier packaging film is formed using film compound lamination. The outer layer, passive barrier layer and active barrier layer are compound laminated with the lamination layer between heated rolls to form the high barrier packaging film.

In still another embodiment of the invention, a high barrier packaging film is formed by spray film compounding.

The high barrier packaging film may be fabricated into bags or pouches for storing products that are sensitive to moisture, such as but not limited to foods and pharmaceuticals. The outer layer forming the high barrier packaging film is compatible with customary printing technologies and may be printed. Most preferably, a package formed with the high barrier packaging film according to the invention has relative humidity (RH %) at 70° F. (21° C.) of five percent (5%) or below within the package when measured approximately 60 minutes from sealing the package, and maintains such RH % over time.

### BRIEF DESCRIPTION OF THE DRAWINGS

The foregoing summary, as well as the following detailed description of the disclosure, will be better understood when read in conjunction with the appended drawings. For the purpose of illustrating the disclosure, there is shown in the drawings embodiments of films which are presently preferred. It should be understood, however, that the disclosure is not limited to the precise arrangements and instrumentalities shown. In the drawings:

FIG. 1 is a schematic exploded view of a high barrier packaging film according to a first embodiment of the invention;

FIG. 2 is a schematic diagram showing a film compound lamination method according to a second embodiment of the invention;

FIG. 3 is a schematic diagram showing a film compound lamination method according to a third embodiment of the invention;

FIG. 4 is a schematic diagram showing a film compound lamination method according to a fourth embodiment of the invention;

FIG. 5 is a schematic diagram showing a film compound lamination method according to a fifth embodiment of the invention;

FIG. 6 is a schematic diagram showing a film compound lamination method according to a sixth embodiment of the invention; and

FIG. 7 is a graph of relative humidity (RH %) at 70° F. (21° C.) versus time (minutes) for condition inside a package made with film comprising prior art polyethylene film as compared to condition inside a package made with a high barrier packaging film according to the invention.

### DESCRIPTION OF THE DISCLOSURE

Certain terminology is used in the following description for convenience only and is not limiting. Unless specifically set forth herein, the terms “a,” “an” and “the” are not limited to one element, but instead should be read as meaning “at least one.” The terminology includes the words noted above, derivatives thereof and words of similar import.

It also should be understood that the terms “about,” “approximately,” “generally,” “substantially” and like terms, used herein when referring to a dimension or characteristic of a component of the invention, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

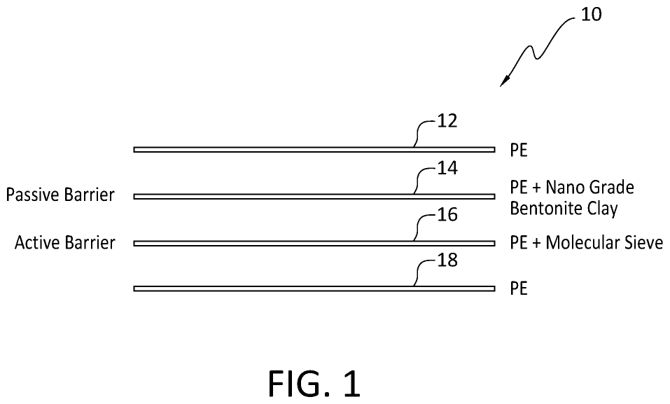

Referring first to FIG. 1, component layers of one embodiment of a high barrier packaging film 10 according to the invention are shown in an exploded view. A first outer layer 12 is made of high-molecular polymer flashing spunbond non-woven fabric or cloth. One exemplary spunbond non-woven fabric is polyethylene (PE) spunbond non-woven fabric sold under the brand TYVEK®, such as TYVEK® 1025D. The first outer layer 12 prevents dust leaking problems, and at the same time is compatible with digital printing technology, making the outer layer 12 printable. The high molecular polymer flashing spunbond non-woven fabric of the outer layer 12 also enhances the strength of the high barrier packaging film 10 according to the invention. As such, the first outer layer 12 is waterproof, breathable, qualitatively light, durable, resistant to tearing and puncturing, and can be recycled.

In an alternative embodiment, rather than using high-molecular polymer flashing spunbond non-woven fabric or cloth, the first outer layer 12 may be made of polymer plastic polyethylene film, such as HDPE or possibly MDPE.

A next layer is a passive barrier layer 14 and comprises a high barrier thin film that prevents moisture transmission through the film due to adding modified nano grade bentonite clay filler into a high molecular polymer. A representative high molecular polymer may be polyethylene, such as LDPE or possibly LLDPE. This next layer 14 provides the high barrier functionality to the high barrier packaging film 10. In one preferred embodiment, the passive barrier layer 14 contains between about 10% to 15% by weight of organic nano bentonite in a high polymer plastic, such as polyethylene, and has a film thickness of about 0.03 mm to about 0.06 mm.

Bentonite, also known as montmorillonite, has a 2:1 lamellar monoclinal structure. According to the type, content and interlayer charge of montmorillonite exchangeable cations, bentonite can be divided into sodium bentonite (alkaline clay), calcium bentonite (alkaline clay), and natural bleached clay (acidic clay). Calcium bentonite also includes calcium and sodium base, and calcium and magnesium base. Bentonite has strong hyposensitivity and expansibility. Bentonite can absorb 8-15 times of its own volume of water, and expands by volume up to 30 times. Bentonite can be dispersed in water in either a gelatinous or suspended form. A medium solution of bentonite dispersed in water has a certain viscosity, thixotropy and lubricity, and a strong cation exchange capacity. Bentonite has certain adsorption capacity for various gases, liquids and organic substances, with the maximum adsorption capacity up to about 5 times its own weight.

The passive barrier layer 14 has good anti-seepage, isolation, chemical corrosion resistance and other plastic film properties. In addition, the added organic sodium bentonite adsorbs water vapor. Such water adsorption causes the bentonite to expand between layers and exert extrusion pressure on the external structure of the polymeric polyethylene film in which it is entrained. Such expansion increases density inside the polymer film and increases the moisture barrier functionality of the barrier layer 14 and the high barrier package film 10 incorporating such barrier layer 14.

To prepare ultrafine organic bentonite, first the bentonite is purified by grinding and soaking in a solvent. Then, the purified bentonite is pulverized by grinding or crushing equipment to obtain ultrafine, nanoscale bentonite particles having particle diameter of 100 nm and below. Finally, the pulverized bentonite particles are “organified” by mixing the ultrafine bentonite particles and an organic cationic surfactant together in an organic coating agent by ion exchange technology. The organic ultrafine bentonite is concentrated and extracted therefrom.

To prepare the passive barrier layer 14, the organic ultrafine bentonite is mixed with high polymer plastic polyethylene for granulation. A masterbatch of granules of the high polymer plastic polyethylene with the organic ultrafine bentonite may be processed into a barrier layer 14 by heating and casting, blowing or extruding to form a film.

Referring still to FIG. 1, another layer 16 of the high barrier package film 10 is an active barrier layer and comprises a moisture barrier thin film that prevents moisture saturating from outside of the package due to adding an ultra-fine molecular sieve desiccant filler to a high molecular polymer. A representative polymer may be polyethylene, such as LLDPE or possibly LDPE. This layer 16 provides additional moisture proof functionality to the film 10. Any moisture transmitted through other film layers (i.e., outer layer 12 and passive barrier layer 14) is absorbed by the active barrier layer 16 with the ultra-fine molecular sieve desiccant. The active barrier layer 16 offers good anti-seepage, isolation, and chemical corrosion resistance. The ultra-fine molecular sieve desiccant powder particles can be evenly dispersed in polymeric polyethylene plastic, and well-integrated therewith. The ultra-fine molecular sieve powder particles physically adsorb water vapor, thereby improving the moisture barrier capability of the high barrier package film 10 that includes the active barrier layer 16 incorporating such powder particles.

A preferred ultra-fine molecular sieve desiccant is a synthetic silicoaluminate with a microporous cubic lattice. The molecular sieve desiccant adsorbs or repels different substance molecules depending on the interior pore sizes of the crystal structure. Substances with a molecular diameter smaller than the pore diameter of the molecular sieve crystal can enter the molecular sieve and thus be adsorbed. Other substances with larger molecular diameters are repelled. The effective pore size of 4A molecular sieve is 0.42 nm. The size of water vapor molecules is about 0.4 nm, which means that water vapor molecules are absorbable by the 4A molecular sieves. For the preferred 4A molecular sieve powder, sodium silicate and sodium aluminate are chemically reacted, crystallized, aged, filtered and dried. A 4A molecular sieve powder is artificially synthesized with a particle size of about 45 μm. These larger particles are then ground or crushed to particle sizes of about 5 μm and below by mechanical or airflow crushing methods. The particles are then sintered at high temperature to produce the 4A molecular sieve powder.

In a preferred embodiment, the active barrier layer 16 comprises about 20% by weight to about 30% by weight, more preferably about 25% by weight of ultra-fine molecular sieve powder (4A molecular sieve powder) in a high polymer plastic, such as polyethylene (LLDPE), and has a film thickness of about 0.03 mm to about 0.06 mm.

Referring again to FIG. 1, a lamination layer 18 is made of a high molecular polymer, such as polyethylene. The lamination layer 18 is formed of a high molecular polymer that has a same or similar composition as the high molecular polymer that comprises the outer layer 12, the next passive barrier layer 14, and the active barrier layer 16.

The high barrier packaging film 10 of the first embodiment that has an outer layer 12 of spun-bonded high-molecular polymer flashing spunbond non-woven fabric or cloth achieves the active and passive barrier functionality at a level comparable to or better than packaging films that include aluminum foil. In the first embodiment, representative amounts of the material of composition are: high-molecular polymer plastic from about 20% to about 95% by weight of the film; high-molecular polymer binder from about 0% to about 40% by weight of the film; and filler from about 5% to about 40% by weight of the film.

The high barrier packaging film 10 of FIG. 1 has been described in a first embodiment in which the main high molecular polymer is polyethylene, and all layers in the laminate comprise PE. The high barrier packaging film alternatively could be formed with another high molecular polymer, such as ethylene acrylic acid copolymer (EAA), ethylene vinyl acetate copolymer (EVA) or ethylene acrylate copolymer (EEA).

It is important that the layers comprising the high barrier packaging film 10 are of a same or similar type of high molecular plastic, and that the binder used when laminating the layers together is of a same or similar type of high molecular plastic. Doing so ensures that the high barrier packaging film 10 is capable of being recycled, and reduces waste.

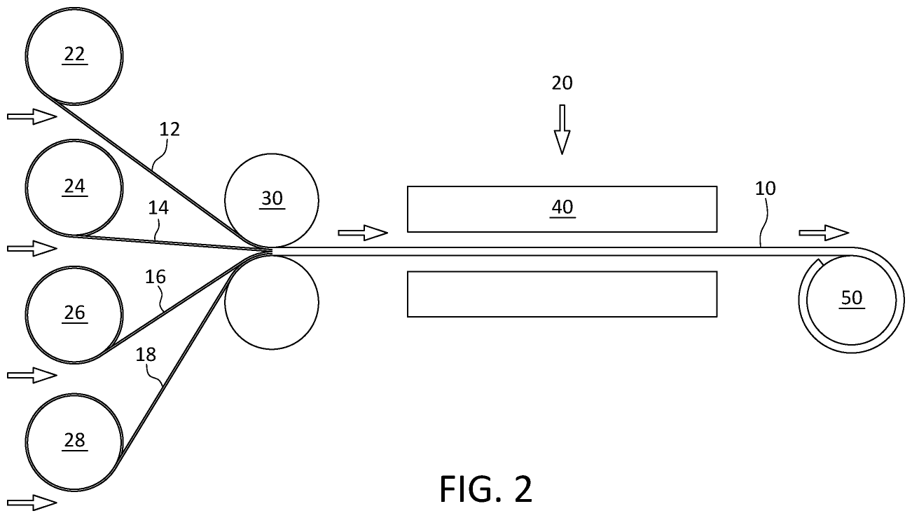

Referring next to FIG. 2, a laminating apparatus 20 is shown schematically. Supply rollers 22, 24, 26 and 28 are provided for the first outer layer 12, the passive barrier layer 14, the active barrier layer 16 and the lamination layer 18, respectively. The layers are unwound from the supply rollers and fed between heated pressing rollers 30, where the layers are compressed together to laminate them into the high barrier packaging film 10. Optionally, the high barrier packaging film 10 is stretched in tenter 40. The stretched film forming the high barrier packaging film 10 is then rolled onto roller 50.

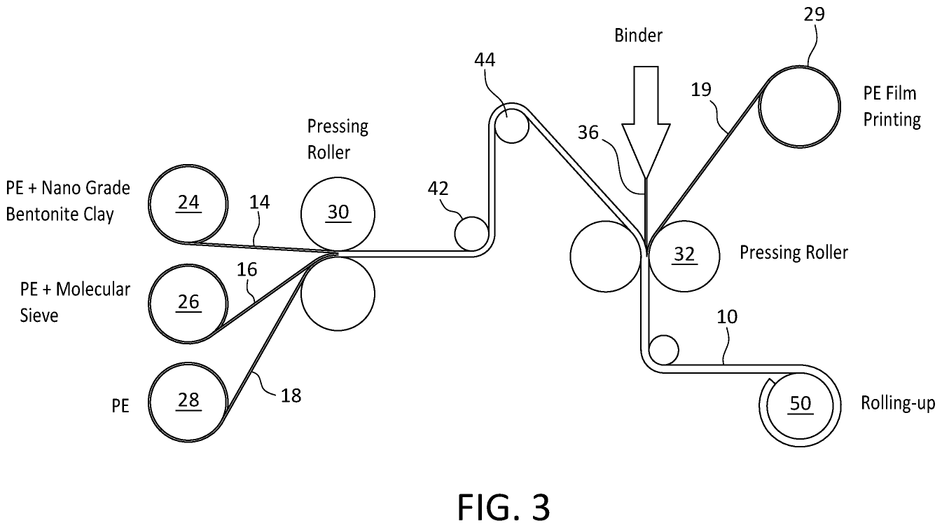

FIG. 3 shows another laminating apparatus in schematic. In this embodiment, supply rollers 24, 26, 28 are provided for the passive barrier layer 14, the active barrier layer 16 and one lamination layer 18. These layers are pressed together in a first set of heated pressing rollers 30. The laminate is then stretched between rollers 42, 44. An outer polyethylene film printing layer 19 unwound from roller 29 is then bound to the stretched laminate (layers 14, 16, 18) with a binder 36 in a second set of heated pressing rollers 32. The finished high barrier packaging film 10 is then rolled up onto roller 50.

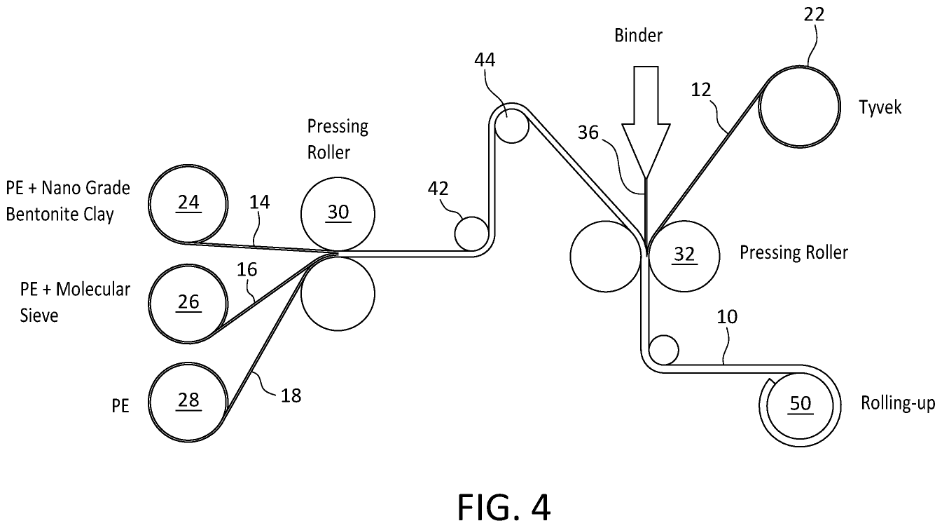

FIG. 4 shows a laminating apparatus comparable to that shown in FIG. 3, except that the outer printing layer 19 is replaced by a layer of TYVEK® polyethylene (PE) spunbond non-woven fabric 12 unwound from roller 22.

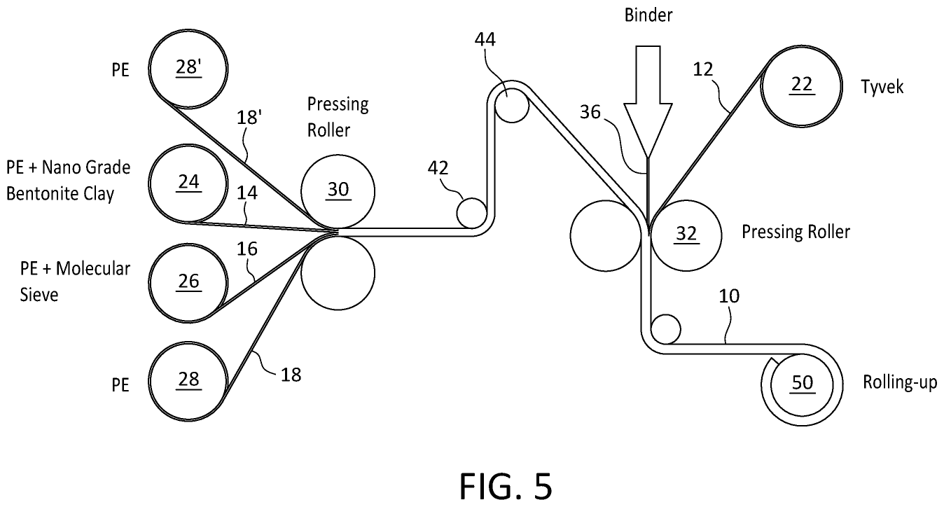

FIG. 5 shows still another laminating apparatus in schematic. In this embodiment, supply rollers 24, 26, 28, 28′ for the passive barrier layer 14, the active barrier layer 16, the lamination layer (designated as PE) 18 and an outer layer (also designated as PE) 18′ are pressed together in a first set of heated pressing rollers 30. An outer layer of TYVEK® polyethylene (PE) spunbond non-woven fabric 12 unwound from roller 22 is then bound to the laminate with a binder 36 in a second set of heated pressing rollers 32. The finished high barrier packaging film 10 is then rolled onto roller 50.

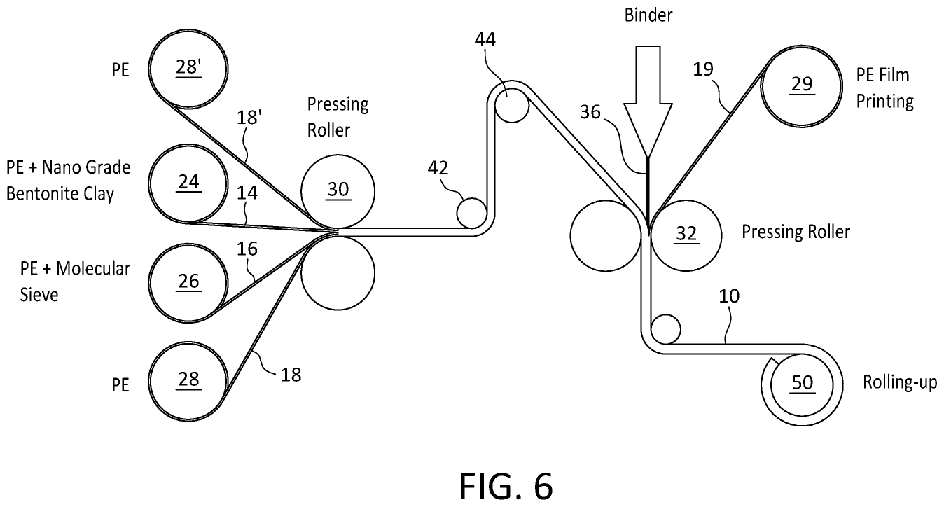

FIG. 6 shows a laminating apparatus comparable to that shown in FIG. 5, except that the outer non-woven fabric in FIG. 5 is replaced by a polyethylene film printing layer 19 unwound from roller 29 that is fed to the second set of heated pressing rollers 32 to be bound with binder 36 with the laminated layers (18′, 14, 16, 18). The finished high barrier packaging film 10 is then rolled onto roller 50.

The laminated layers (such as the passive barrier layer 14, the active barrier layer 16 and one lamination layer 18) may be spray film compounded together to form the finished high barrier packaging film 10.

### EXAMPLES

Example 1: The outer layer comprised spunbond non-woven fabric (main ingredient high density polyethylene (HDPE)) available from DuPont as TYVEK® 1025D. The second layer comprised nano grade bentonite 10% by weight LDPE high molecular plastic film having a film thickness of 0.030 mm. The third layer comprised ultra-thin molecular sieve desiccant 25% by weight LLDPE plastic film having a film thickness of 0.040 mm. The lamination layer comprised high-molecular polymer plastic LDPE. The layers were introduced to heated rollers and compressed together using film compound lamination to create a high barrier packaging film.

Example 2: The outer layer comprised spunbond non-woven fabric (main ingredient polyethylene (PE)) of basis weight 50 g/m². The second layer comprised nano grade bentonite 15% by weight LDPE high molecular plastic film having a film thickness of 0.025 mm. The third layer comprised ultra-thin molecular sieve desiccant 20% by weight LLDPE plastic film having a film thickness of 0.030 mm. The lamination layer comprised high-molecular polymer plastic LDPE. The layers were introduced to heated rollers and compressed together using film compound lamination to create a high barrier packaging film.

Example 3: The outer layer comprised spunbond non-woven fabric (main ingredient polyethylene (PE)) of basis weight 55 g/m². The second layer comprised nano grade bentonite 8% by weight LDPE high molecular plastic film having a film thickness of 0.035 mm. The third layer comprised ultra-thin molecular sieve desiccant 30% by weight LLDPE plastic film having a film thickness of 0.040 mm. The lamination layer comprised high-molecular polymer plastic LDPE. The layers were introduced to heated rollers and compressed together using film compound lamination to create a high barrier packaging film.

Bags or pouches may be made with the high barrier packaging films according to the invention. The bags or pouches are suitable for storing products that are moisture sensitive, such as but not limited to foods and pharmaceuticals. The moisture barrier properties of the high barrier packaging films of the invention are comparable to packaging laminates that include a metal. For example, the relative humidity (RH %) at 70° F. (21° C.) within a pouch fabricated with the high barrier packaging film of the present invention preferably remains at or below about 5%.

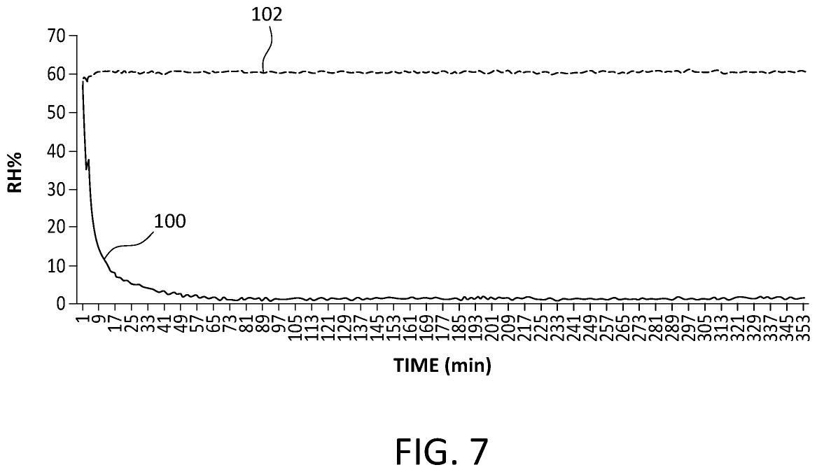

A sealed pouch for packaging foods having dimensions of approx. 15 cm by 20 cm is formed with the high barrier package film of Example 1. Another sealed pouch for packaging foods having dimensions of approx. 15 cm by 20 cm is formed with a polyethylene package film. The relative humidity (RH %) inside each package is measured continuously with a hygrometer for 8 hours. The RH % measured over time is shown in the graph depicted in FIG. 7. Within 60 minutes from being sealed, the pouch made with the high barrier package film of the invention 100 maintains RH % at 2%, whereas the pouch made with polyethylene package film without a desiccant layer 102 does not reduce relative humidity, and the RH % remained at 60%.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

1. A high barrier packaging film, comprising:
an outer layer of spunbond nonwoven fabric comprising a first high molecular polymer;
a passive barrier layer comprising the first high molecular polymer with nanoparticles of bentonite clay dispersed therein;
an active barrier layer comprising the first high molecular polymer with desiccant particles dispersed therein; and
a lamination layer comprising the first high molecular polymer;
wherein said outer layer, passive barrier layer and active barrier layer are compound laminated with the lamination layer to form the high barrier packaging film.

2. The high barrier packaging film of claim 1, wherein the first high molecular polymer is one polymer selected from the group consisting of: polyethylene, ethylene acrylic acid copolymer, ethylene vinyl acetate copolymer and ethylene acrylate copolymer.

3. The high barrier packaging film of claim 1, wherein the first high molecular polymer is polyethylene.

4. The high barrier packaging film of claim 1, wherein none of the outer layer, passive barrier layer, and active barrier layer comprise a metal.

5. The high barrier packaging film of claim 1, wherein none of the outer layer, passive barrier layer and active barrier layer comprise aluminum.

6. The high barrier packaging film of claim 1, wherein the desiccant particles comprise ultra-fine molecular sieve desiccant.

7. The high barrier packaging film of claim 1, further comprising a second lamination layer comprising the first high molecular polymer compound laminated with the outer layer, passive barrier layer and active barrier layer.

8. The high barrier packaging film of claim 1, further comprising a printing layer bound to the high barrier packaging film.

9. A high barrier packaging film, comprising:
an outer layer of a first high molecular polymer;
a passive barrier layer comprising the first high molecular polymer with nanoparticles of bentonite clay dispersed therein;
an active barrier layer comprising the first high molecular polymer with desiccant particles dispersed therein; and
a lamination layer comprising the first high molecular polymer;
wherein said outer layer, passive barrier layer and active barrier layer are compound laminated with the lamination layer to form the high barrier packaging film.

10. A method of making a high barrier packaging film, comprising:
providing (a) an outer layer of a first high molecular polymer, (b) a passive barrier layer comprising the first high molecular polymer with nanoparticles of bentonite clay dispersed therein, and (c) an active barrier layer comprising the first high molecular polymer with desiccant particles dispersed therein;
laminating at least layers (b) and (c) together with (d) a lamination layer comprising the first high molecular polymer between heated rollers to form the high barrier packaging film.

11. The method of claim 10, further comprising: providing (d′) a second lamination layer comprising the first high molecular polymer;
laminating layers (d′), (b), (c) and (d) between a first set of heated rollers to form a composite laminate; and
binding layer (a) to the composite laminate.

12. The method of claim 11, wherein binding layer (a) to the composite laminate is by compressing between heated rollers the composite laminate and the layer (a) with a binder.

13. The method of claim 10, wherein layer (a) is laminated together with layers (b), (c) and (d) between the heated rollers.

14. The method of claim 10, wherein the first high molecular polymer is one polymer selected from the group consisting of: polyethylene, ethylene acrylic acid copolymer, ethylene vinyl acetate copolymer and ethylene acrylate copolymer.

15. The method of claim 10, wherein the first high molecular polymer is polyethylene.

16. The method of claim 10, wherein none of the outer layer, passive barrier layer, and active barrier layer comprise a metal.

17. The method of claim 10, wherein none of the outer layer, passive barrier layer and active barrier layer comprise aluminum.

18. The method of claim 10, wherein the desiccant particles comprise ultra-fine molecular sieve desiccant.

19. The method of claim 10, wherein the outer layer comprises spunbond nonwoven fabric comprising the first high molecular polymer.

20. A bag or pouch, comprising: the high barrier packaging film of claim 1.

21. The bag or pouch of claim 20, wherein the relative humidity (RH %) at 70° F. (21° C.) inside the bag or pouch is 5% or less when measured at least 60 minutes from sealing the bag or pouch.

22. A bag or pouch, comprising: the high barrier packaging film of claim 9.

23. The bag or pouch of claim 22, wherein the relative humidity (RH %) at 70° F. (21° C.) inside the bag or pouch is 5% or less when measured at least 60 minutes from sealing the bag or pouch.

24. A high barrier packaging film, consisting essentially of:
an outer layer of spunbond nonwoven fabric comprising a first high molecular polymer;
a passive barrier layer comprising the first high molecular polymer with nanoparticles of bentonite clay dispersed therein;
an active barrier layer comprising the first high molecular polymer with desiccant particles dispersed therein; and
a lamination layer comprising the first high molecular polymer;
wherein said outer layer, passive barrier layer and active barrier layer are compound laminated with the lamination layer to form the high barrier packaging film; and
wherein none of the outer layer, passive barrier layer, and active barrier layer comprise a metal.

25. A bag or pouch comprising: the high barrier package film of claim 24.

26. The bag or pouch of claim 25, wherein the relative humidity (RH %) at 70° F. (21° C.) inside the package is 5% or less when measured at least 60 minutes from sealing the bag or pouch.
